(19) United States
(12) Patent Application Publication
(10) Pub. No.: US 2025/0279592 A1
(43) Pub. Date: Sep. 4, 2025

(54) BRANCH CONNECTOR FOR MAIN LINES

(71) Applicant: Guangzhou Rising Dragon Recreation Industrial Co., Ltd., Guangzhou (CN)

(72) Inventors: Richeng HUANG, Guangzhou (CN); Bo PENG, Guangzhou (CN)

(73) Assignee: Guangzhou Rising Dragon Recreation Industrial Co., Ltd., Guangzhou, GD (CN)

(21) Appl. No.: 18/801,434

(22) Filed: Aug. 12, 2024

(30) Foreign Application Priority Data
Feb. 29, 2024 (CN) 202420392089.X

(51) Int. Cl. H01R 4/2433

(52) U.S. Cl. CPC H01R 4/2433

(57) ABSTRACT

A branch connector for main lines, includes a first shell and a second shell. A groove for receiving a main line is formed in the first shell, mutually insulated piercing pieces are arranged on the first shell or the second shell, and each piercing piece has one end connected to a branch line and another end configured as a sharp piercing head for piercing through an insulation layer of the main line when the first shell and the second shell are buckled together. In use, the main line is placed in the groove of the first shell, then the first shell and the second shell are pressed to be buckled together, at this moment, the main line will be squeezed, and the insulation layer of the main line will be pierced by the piercing pieces, such that the main line and the branch line are electrically connected to each other.

### FIELD

The invention relates to the technical field of connection of electric lines or cables, in particular to a branch connector for main lines.

### BACKGROUND

During construction and maintenance of a power system, the connection of a main line and a branch line is indispensable. Traditionally, such an operation comprises the steps of stripping an insulation layer of the main line, connecting the branch line to the main line, and sealing with adhesive tape or other sealing materials. However, such a connection method has obvious defects. First, this connection method has high process requirements and a complex installation process, thus being unsuitable for large-scale tasks. Second, the adhesive tape and other sealing materials are prone to aging to lead to a reduction of the sealing performance with time and possibly result in oxidization or short-circuiting of metal lines inside, thus threatening safe operation of the power system.

Although there have been some connection devices on the market, these connection devices typically comprise two separated connecting members and are installed by means of pliers and other devices, or it will take a long time to install these connection devices, thus increasing the installation complexity and the time cost.

Therefore, it is necessary to develop an efficient and reliable connection device to connect main lines and branch lines.

### SUMMARY

In view of the defects in the prior art, the invention provides a branch connector for main lines, which can easily connect branch lines and main lines in a circuit system.

The present invention provides a branch connector for a main line, being used for connecting a branch line and the main line in a circuit system. The branch connector comprises a first shell providing a groove for receiving the main line; and a second shell rotatably connected to the first shell. A plurality of mutually insulated piercing pieces are arranged on the first shell or the second shell, and each of the piercing pieces has one end connected to the branch line and another end configured as a sharp piercing head used for piercing through an insulation layer of the main line when the first shell and the second shell are buckled together.

Preferably, the first shell and the second shell are rotatably connected by means of a spindle, and a buckle structure is arranged at ends, away from the spindle, of the first shell and the second shell.

Preferably, the buckle structure comprises a buckle head and a buckle socket matched with the buckle head, and the buckle head and the buckle socket are arranged on the first shell and the second shell respectively.

Preferably, the first shell and the second shell are respectively configured as a quasi-rectangular shell and an L-shaped shell, the L-shaped shell comprises a first handle portion and a second handle portion shorter than the first handle portion, an end of the first handle portion is rotatably connected to an end of the quasi-rectangular shell, the buckle head or the buckle socket is arranged on a side wall, close to the first handle portion, of the second handle portion, and the buckle socket or the buckle head is arranged on a side wall, close to the second handle portion, of the quasi-rectangular shell.

Preferably, a tail section of the second handle portion is configured as a cutout.

Preferably, the buckle socket and the buckle head are respectively arranged on opposite surfaces of the first shell and the second shell which are buckled together.

Preferably, a plurality of said first spacer bars are arranged in the groove of the first shell, and a plurality of said second spacer bars are arranged at positions, corresponding to the first spacer bars, of the second shell.

Preferably, one said first spacer bar and one said second spacer bar are arranged, or three said first spacer bars and three said second spacer bars are arranged.

Preferably, ends, away from the sharp piercing heads, of the piercing pieces are arranged on a PCB, and the PCB is connected to the branch line.

Preferably, the sharp piercing heads are configured as V-structures.

Compared with the prior art, the invention has the following beneficial effects:

When the branch connector for main lines provided by the invention is used, a main line is placed in the groove of the first shell, and then the first shell and the second shell are pressed to be buckled together, at this moment, the main line will be squeezed by the first shell and the second shell, and an insulation layer of the main line will be pierced by piercing pieces, such that the main line and a branch line are connected. In this way, the branch connector for main lines can quickly and firmly connect the main line and the branch line simply by pressing, the main line and the branch line are unlikely to be disconnected, the working efficiency is greatly improved, and the complexity and errors of manual operation are reduced. Moreover, the branch connector for main lines can be installed at any position of the main line, so installers can easily select a suitable position for installing the branch connector.

### BRIEF DESCRIPTION OF THE DRAWINGS

FIG. 1 is a structural view of a branch connector for main lines in use according to the invention;

FIG. 2 is an exploded structural view of the branch connector for main lines according to the invention;

FIG. 3 is a partial structural view of the branch connector for main lines according to the invention;

FIG. 4 is a structural view of a first shell according to the invention;

FIG. 5 is a connection diagram of a PCB and a branch line according to the invention;

FIG. 6 is a schematic view of a second shell according to the invention; and

FIG. 7 is a structural view of the branch connector for main lines in use according to the invention.

Wherein,
1, branch line; 2, main line; 3, first shell; 4, second shell; 6, spindle; 7, PCB; 31, groove; 32, piercing piece; 33, arc-shaped notch; 35, first shell body; 36, extension plate; 37, rotation hole; 38, arc-shaped notch; 39, recess; 310, first spacer bar; 41, long handle portion; 42, short handle portion; 43, through-hole; 44, second spacer bar; 51, buckle; 52, buckle socket; 53, slot.

### DESCRIPTION OF THE EMBODIMENTS

The embodiments described below are merely illustrative ones of the invention, and are not all possible ones of the invention. All other embodiments obtained by those ordinarily skilled in the art based on the following ones without creative labor should also fall within the protection scope of the invention.

### Embodiment 1

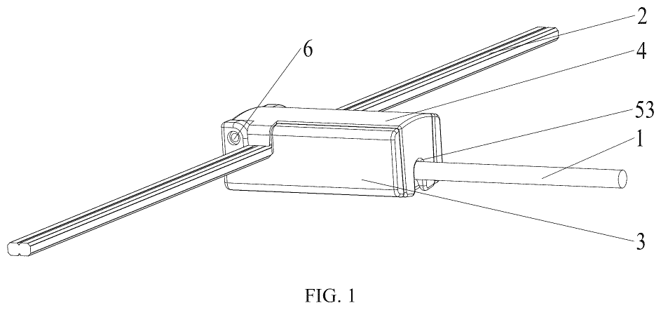

Referring to FIGS. 1-6, Embodiment 1 provides a branch connector for main lines, which is used for connecting a branch line 1 and a main line 2 in a circuit system. The branch connector comprises a first shell 3 and a second shell 4 rotatably connected to the first shell 3 by means of a spindle 6. A groove 31 for receiving the main line 2 is formed in the first shell 3, a plurality of mutually insulated piercing pieces 32 are arranged at the bottom of the groove 31 of the first shell 3, and each of the piercing pieces 32 has one end connected to the branch line 2 and the other end configured as a sharp piercing head used for piercing through an insulation layer of the main line 2 when the first shell 3 and the second shell 44 are engaged together. It should be noted that the circuit system in this embodiment is preferably an LED circuit system.

Referring to FIGS. 1, 2 and 4, preferably, a buckle structure is arranged at ends, away from the spindle 6, of the first shell 3 and the second shell 4. The buckle structure comprises a buckle head 51 and a buckle socket 52 matched with the buckle head 51, and the buckle head 51 and the buckle socket 52 are arranged on the first shell 3 and the second shell 4 respectively.

Preferably, the first shell 3 and the second shell 4 are respectively configured as a quasi-rectangular shell and an L-shaped shell buckled and connected to the quasi-rectangular shell. The L-shaped shell comprises a long handle portion 41 and a short handle portion 42, one end of the long handle portion 41 is rotatably connected to one end of the quasi-rectangular shell, the buckle head 51 or the buckle socket 52 is arranged on a side wall, close to the long handle portion 41, of the short handle portion 42, and the buckle socket 52 or the buckle head 51 matched with the buckle head 51 or the buckle socket 52 is arranged on a side wall, close to the short handle portion 42, of the quasi-rectangular shell.

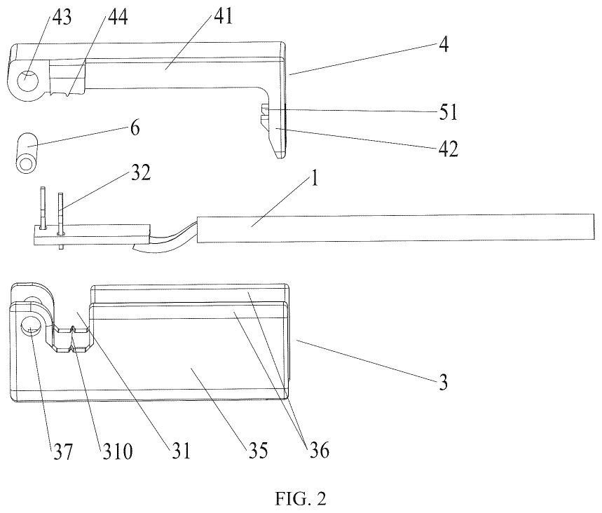

Referring to FIGS. 2, 4 and 6, specifically, in this embodiment, the first shell 3 is a quasi-rectangular shell, and the second shell 4 is an L-shaped shell. It should be noted that the first shell 3 comprises a first shell body 35 and extension plates 36 arranged at an end in a length direction of the first shell body 35 and extending away from one end of the first shell body 35, a rotation hole 37 is formed in one end of each of the two extension plates 36, a through-hole 43 is formed in an end, away from the short handle portion 42, of the long handle portion 41 of the second shell 4, and the spindle 6 penetrates through the through-hole 43 and has two ends extending out of the through-hole 43 to be inserted into the two rotation holes 37, such that the first shell 3 and the second shell 4 are rotatably connected.

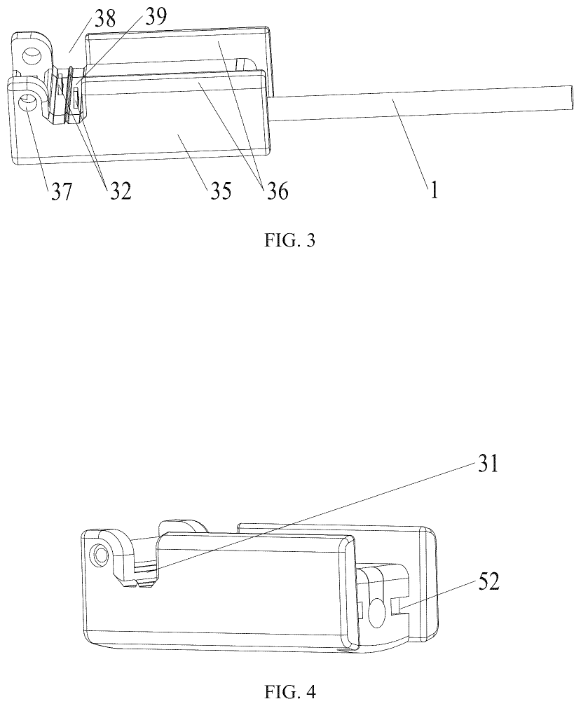

Referring to FIG. 3, in this embodiment, two notches 38 facing each other are formed in sides, close to the rotation holes 37, of the two extension plates 36, the first shell body 35 is concaved from a side close to the extension plates 36 to a side away from the extension plates 36 to form a recess 39, and the notches 38 and the recess 39 form the groove 31 in this embodiment. Preferably, the notches 38 and the recess 39 are aligned with each other.

Referring to FIG. 6, preferably, a tail section of the short handle portion 43 of the second shell 4 away from the long handle portion 41 defines an arc-shaped cutout 33 which is inclined from a side close to the long handle portion 41 toward a side away from the long handle portion 41. The cross-section of the arc-shaped cutout 33 has approximately a trapezoidal, arc or triangular shape. When the first shell 3 and the second shell 4 need to be opened, users just need to hold a portion of the second shell 4 adjacent the arc-shaped cutout 33 and then apply a force to disconnect the first shell 3 from the second shell 4, and then the first shell 3 and the second shell 4 can be opened.

Alternatively, the buckle socket and the buckle head are respectively arranged on opposite surfaces, i.e., the top surface of the first shell 3 and the bottom surface of the second shell 4, of the first shell 3 and the second shell 4 which are buckled together. When the branch connector is installed, users just need to press the first shell 3 and the second shell 4 to cause the buckle head to be engaged in the buckle socket, so as to firmly buckle and connect together the first shell 3 and the second shell 4. In a case where the buckle socket and the buckle head are arranged reversely, the first shell 3 may be configured as a quasi-rectangular structure, and the second shell 4 may be configured as a rectangular sheet structure.

Referring to FIG. 2, preferably, a plurality of first spacer bars 310 are arranged in the groove 31 of the first shell 3, and second spacer bars 44 are arranged at positions, corresponding to the first spacer bars 310, of the second shell 4. By arranging the first spacer bars 310 and the second spacer bars 44, main lines 2 installed in the groove can be further isolated and fixed, thus improving the insulation performance of the whole connector and reducing the risk of short-circuiting. Moreover, by arranging the first spacer bars 310 and the second spacer bars 44, the main lines 2 can be installed in the groove 31 more stably and are unlikely to move or twist, thus guaranteeing the stability of electrical connection.

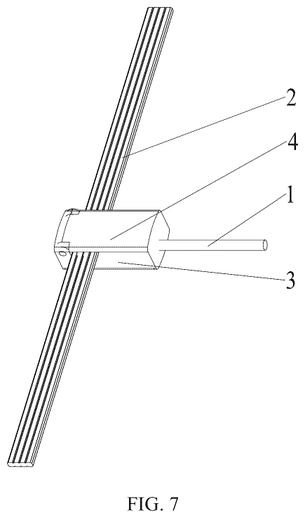

Preferably, one first spacer bar 310 and one second spacer bar 44 are arranged, or three spacer bars 310 and three second spacer bars 44 are arranged. Referring to FIG. 1, in a case where one first spacer bar 310 and one second spacer bar 44 are arranged, two piercing pieces 32 are correspondingly arranged on opposite two sides of the first spacer bar 310 and used for connecting two main lines and the branch line 1. Referring to FIG. 7, in a case where three spacer bars 310 and three second spacer bars 44 are arranged, four piercing pieces 32 are correspondingly arranged between the first spacer bars 310 and on sides, away from the adjacent first spacer bars 310, of the outermost first spacer bars 310 and used for connecting four main lines and the branch line 1.

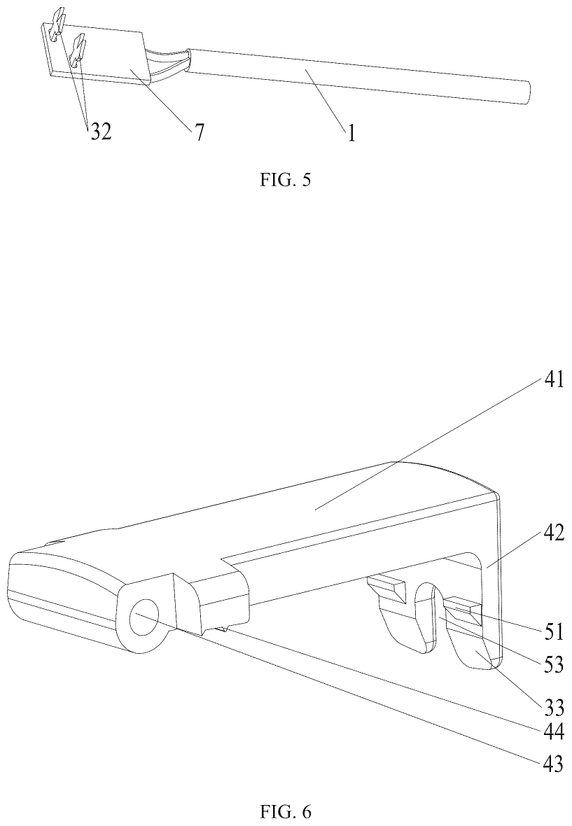

Referring to FIGS. 2 and 5, preferably, ends, away from the sharp piercing heads, of the piercing pieces are arranged on a PCB 7, and the PCB 7 is connected to the branch line 1. In this embodiment, the PCB 7 is arranged at the bottom of the groove 31 of the first shell 3, and the branch line 1 is arranged in the first shell 3 and extends out from an end, away from the spindle 6, of the first shell 3. In the application, to easily buckle the second shell 3 on the first shell 3, a U-shaped slot 53 is formed in the middle of the short handle portion 42 of the second shell 4, and when the first shell 3 and the second shell 4 are buckled together, the branch line 1 is buckled in the slot 53.

Referring to FIG. 5, preferably, the sharp piercing heads are configured as V-shaped structures. Each V-shaped structure comprises a pair of sharp prongs with a slot formed therebetween. By configuring the piercing heads as V-shaped structures, the sharp piercing heads have a better penetrating capacity and cutting capacity when piercing through the insulation layer of the main line 2, thus improving connection reliability. In addition, the sharp piercing heads configured as V-shaped structures can better adapt to the diameters of different main lines 2 to reduce damage to the inside of the main lines 2 during the piercing process, thus improving connection safety.

When the branch connector for main lines provided by the invention is used, the main line 2 is placed in the groove 31 of the first shell 3, and then ends of the first shell 3 and the second shell 4 away from the pivot connection end are pressed to allow the buckle head 51 to be buckled in the buckle socket 52, such that the first shell 3 and the second shell 4 are buckled together. During the first shell 3 and the second shell 4 are buckled together, the main line 2 will be squeezed and the piercing pieces 32 of the first shell 3 will pierce through the insulation layer of the main line 2 to be clamped between electric wires of the main line, such that the main line 2 and the branch line 1 are connected electrically.

In this way, the branch connector for main lines can quickly and firmly connect the main line 2 and the branch line 1 simply by pressing, and the main line and the branch line are unlikely to be disconnected, the working efficiency is greatly improved, and the complexity and errors of manual operation are reduced. Moreover, the branch connector for main lines can be installed at any position of the main line 2, so installers can easily select a suitable position for installing the branch connector. In addition, the main line 2 is arranged between the first shell 3 and the second shell 4 and is in contact with less air, such that the sealing and waterproofing effect are better.

### Embodiment 2

Embodiment 2 is substantially the same with Embodiment 1 except that a plurality of mutually insulated piercing pieces are arranged on the second shell and correspond to the groove of the first shell. In use, the main line is placed in the groove of the first shell, then ends of the first shell and the second shell away from the pivot connection end are pressed to allow the buckle head to be buckled in the buckle socket, and the piercing pieces on the second shell pierce through the insulation layer of the main line arranged in the groove of the first shell under the pressure between the first shell and the second shell, such that the main power and the branch line are connected.

The embodiments disclosed above are merely several preferred ones of the invention and are not intended to limit the protection scope of the invention. Therefore, all equivalent modifications made according to the patent scope of the invention should also fall within the scope of the invention.

1. A branch connector for a main line, being used for connecting a branch line and the main line in a circuit system, the branch connector comprising:
a first shell providing a groove for receiving the main line; and
a second shell rotatably connected to the first shell;
wherein a plurality of mutually insulated piercing pieces are arranged on the first shell or the second shell, and each of the piercing pieces has one end connected to the branch line and another end configured as a sharp piercing head used for piercing through an insulation layer of the main line when the first shell and the second shell are buckled together.

2. The branch connector for main lines according to claim 1, wherein the first shell and the second shell are rotatably connected by means of a spindle, and a buckle structure is arranged at ends, away from the spindle, of the first shell and the second shell.

3. The branch connector for main lines according to claim 2, wherein the buckle structure comprises a buckle head and a buckle socket matched with the buckle head, and the buckle head and the buckle socket are arranged on the first shell and the second shell respectively.

4. The branch connector for main lines according to claim 3, wherein the first shell and the second shell are respectively configured as a quasi-rectangular shell and an L-shaped shell, the L-shaped shell comprises a first handle portion and a second handle portion shorter than the first handle portion, an end of the first handle portion is rotatably connected to an end of the quasi-rectangular shell, the buckle head or the buckle socket is arranged on a side wall, close to the first handle portion, of the second handle portion, and the buckle socket or the buckle head is arranged on a side wall, close to the second handle portion, of the quasi-rectangular shell.

5. The branch connector for main lines according to claim 4, wherein a tail section of the second handle portion defines a cutout.

6. The branch connector for main lines according to claim 3, wherein the buckle socket and the buckle head are respectively arranged on opposite surfaces of the first shell and the second shell which are buckled together.

7. The branch connector for main lines according to claim 1, wherein a plurality of said first spacer bars are arranged in the groove of the first shell, and a plurality of said second spacer bars are arranged at positions, corresponding to the first spacer bars, of the second shell.

8. The branch connector for main lines according to claim 1, wherein one said first spacer bar and one said second spacer bar are arranged, or three said first spacer bars and three said second spacer bars are arranged.

9. The branch connector for main lines according to claim 1, wherein ends, away from the sharp piercing heads, of the piercing pieces are arranged on a PCB, and the PCB is connected to the branch line.

10. The branch connector for main lines according to claim 9, wherein the sharp piercing heads are configured as V-shaped structures.

11. The branch connector for main lines according to claim 4, wherein a U-shaped slot is defined in a middle of the second handle portion of the second shell for holding the branch line.
